(19) United States
(12) Patent Application Publication
(10) Pub. No.: US 2004/0199483 A1
(43) Pub. Date: Oct. 7, 2004

(54) Design work assistance apparatus

(75) Inventors: Ichiro Nishigaki, Ishioka (JP); Hiroyuki Nemoto, Tokyo (JP)

Correspondence Address: McDermott, Will & Emery, 600, 13th Street, N.W., Washington, DC, 20005-3096, US

(73) Assignee: HITACHI, LTD.

(21) Appl. No.: 10/732,284

(22) Filed: Dec. 11, 2003

(30) Foreign Application Priority Data
Apr. 1, 2003 (JP) 2003-098438

(51) Int. Cl. G06N 5/02

(52) U.S. Cl. 706/46

(57) ABSTRACT

In design work assistance apparatus, a personal process template producing means produces a template for use of personal works from a common process template, indicating flows of design work processes by an order of unit work processes. A relation means relates design knowledge, such as, design information and design tools, etc., to both the common process template and the personal process template produced, and stores them into a knowledge database. A useful knowledge extraction means extracts the design knowledge to be provided for design workers from the common process template and the personal process template. And, a knowledge visualizing means visualizes the extracted design knowledge, to be provided for each of the design workers.

### BACKGROUND OF THE INVENTION

The present invention relates to a design work assistance apparatus for supporting rationalization and high productivity or efficiency of design works, by using a computer, a database, as well as, various kinds of software, and in particular, relates to a navigation system for design works, for automatically providing useful information to be referred to and tools to be used effectively by a designer, thereby guiding and assisting the design works.

Due to advances of environment of computers, such as personal computers and/or networks, etc., for example, there are many cases of using such the environment of the computers and/or the various kinds of software, in the design works in the manufacturing industries, too.

For example, in the design works are used a three-dimensional (3D) CAD (Computer Aided Design) system for producing the configuration of a product in the form of configuration model data, a CAE (Computer Aided Engineering) system for checking the product on performances and/or reliability thereof through a numerical analysis simulation with using the configuration model data, a document production tools for producing design data and/or design specification, a database system for storing the design documents into a database, and a search visualizing tool for enabling to refer to information, which is necessary for the design works, from the various kinds of database, etc.

There are two (2) kinds of methods or ways to master or use those software tools and the design information, effectively, but without error, which are utilized in the design works. A first one of those methods is described, for example, in Japanese Patent Laying-Open No. Hei 10-240778 (1998), in particular, on pages 4-5, and in FIGS. 5-8 thereof. With this method, onto one (1) piece of screen are integrated a start command of the software tool necessary for design works and an access command to the design data, and from this screen can be executed the software tools mentioned above and/or refer to and register the design data. This method is called by a name, “portal”, in general.

On this portal screen, there are disposed icons of those various kinds of commands, and a designer picks up the icon, thereby starting the necessary software tool and/or referring to the design data or materials. With this portal method, it is possible to lighten the confusing works, such as, start-up processes for the various kinds of software tools, and also search on data or materials from the database, which are located scattering.

With a second method, the contents and steps of the design works are defined in the form of a design template, thereby guiding the design works along with the steps described in that design template. On the design template displayed on an operation screen, there are disposed the icons indicative of the contents of each work process in the order of the works, and then the designer proceeds her/his design works along with that order of the works while picking up the icons. In each work process, there is/are defined the software tool(s) necessary for that work, the data/material to be referred to, and formats of the materials to be produced, and so on, in advance, and then the designer picks up the icon of the work process and uses those software tools and the relevant data/materials defined therein.

With this second method, comparing to the first method mentioned above, it is possible to define the necessary software tools and the relevant materials, by a unit of design work. Also, as is disclosed in Japanese Patent Laying-Open No. Hei 6-19691 (1994), for example, in particular, on pages 4-5, and in FIGS. 1, 3 and 5 thereof, there is proposed a system for assisting the production works of design drawings by using design processing information.

However, in the design work assistance apparatus with using the conventional software system, there are such drawbacks, as will be mentioned below. Thus, first of all, with the conventional design work assistance apparatus, it is possible to visualize a listing table of the information and/or the design tools, which have possibility to be used therein, but only in relation to the steps or contents of the works that were set up in advance. However, it is impossible to determine the necessity for the design workers on each of the information and/or the tools, automatically, thereby to automatically provide those to the design workers.

Conventionally, the design workers must use the information and the tools necessary for them from that listing table of the information and tools, being possible to be used, and if such the possible information and the tools to be used are large in the number thereof, there is a necessity of a lot of times and labors for selecting the information and the tools at her/his desire. In particular, with the design assistance apparatus, in which the information are stored automatically, relating to the contents of the steps and the works, there may be a case where a lot of the unnecessary ones are contained in the possible information and the tools to be used, thereby bringing about a heavy burden upon the design workers. Also, in the case where a plural number of process templates are used in common, in which the steps of the design works are described, there will be caused the drawbacks being similar thereto.

Second, with such the conventional design assistance apparatus, it is impossible to provide the information and the tools at good timing, appropriately, in particular, responding to the design scenes and/or design work histories. Thus, it is impossible to deletes the following information from the list of the information to be referred to, as being unnecessary; such as, design information, which was referred to many times in the past, a design know-how, which was registered by a person her/himself, a design memo, which was memorized by other design worker, personally, etc., for example. Accordingly, also in this case, it necessitates a lot of times and labors for works of selecting the necessary information and tools. Further, with such the design work assistance apparatus, there is a necessity of assisting a new design work, while using the design work histories of the past, effectively. Therefore, there is a demand upon such a design assistance apparatus of a grow-up type, being able to change the method of design work assistance, flexibly, depending upon the design work histories.

### BRIEF SUMMARY OF THE INVENTION

An object, according to the present invention, is to accomplish a design assistance apparatus, being able to extract and provide information and tools being useful for each of design workers, from the various information and tools to be used in the design works, effectively, on an appropriate scene of the design works.

For accomplishing such an object as mentioned above, according to the present invention, there is provided a design work assistance apparatus, for guiding design works, sequentially, along with a process template, defining steps of design works therein, comprising: a personal process template producing means for producing a template for use of personal works from a common process template, indicating flows of design work processes by an order of unit work processes; a relation means for relating design knowledge, including design information and design tools therein, to said common process template and said personal process template, thereby storing them into a knowledge database; a useful knowledge extraction means for extracting the design knowledge to be provided for design workers from said common process template and said personal process template; and a knowledge visualizing means for visualizing the design knowledge extracted, thereby to be provided for each of the design workers.

### BRIEF DESCRIPTION OF THE SEVERAL VIEWS OF THE DRAWING

Those figures, e.g., FIGS. 1 to 11, are views for explaining a design work system, according to an embodiment of the present invention, wherein:

FIG. 1 is a block diagram for showing the configuration of the design work system;

FIG. 2 is a view of an example of a process template;

FIG. 3 is a view for explaining the data structure of the process template;

FIG. 4 is a view for showing a relationship between a common process template and a personal process template for persona use;

FIG. 5 is a view for showing a relationship between the common process template and the personal process template, and a knowledge database;

FIG. 6 is a view for explaining the processes of storing design knowledge;

FIG. 7 is a view for explaining the processes of visualizing the design knowledge;

FIG. 8 is a flowchart for showing the processing steps of storing the design knowledge;

FIG. 10 shows an example of an operation screen when re-starting the design work; and

FIG. 11 shows an example of the operation screen of new information and design knowledge, being high in publicity thereof.

### DETAILED DESCRIPTION OF THE INVENTION

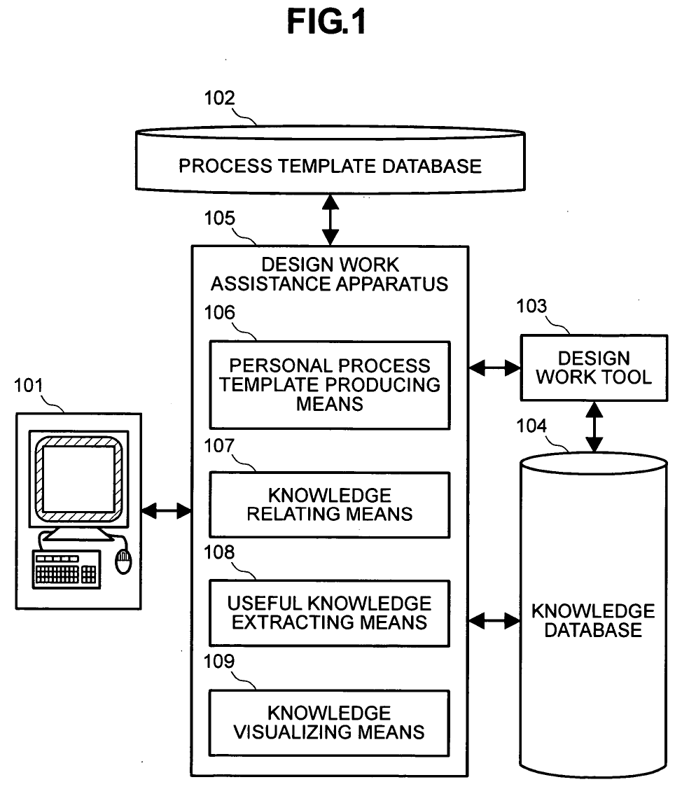

FIG. 1 is a block diagram for showing the system configuration of the design work assistance system, according to one embodiment of the present invention. The design work assistance system shown as the present embodiment comprises; an input/output device 101, a process template database 102, a design work took 103, a knowledge database 104, and a design work assistance apparatus 105. The design work assistance apparatus 105 includes therein; a personal process template producing means 106, a knowledge relating means 107, a useful knowledge extracting means 108, and a knowledge visualizing means 109. The input/output device 101 has a keyboard, a mouse, and a display, etc. The process template database 102 stores therein the common process templates, in which various kinds of design work processes are described, and also the personal templates.

The design work tool 103 is built up with a document production tool to be used in actual design works, an engineering tool, and a design data referring tool, etc. The knowledge database 104 stores therein the design data and/or analysis data, which are produced by means of the design work tool 103. The design work assistance apparatus 105 gives a guidance on the steps of design works along with the process template selected from the process template database 102, and it also produces and stores the design knowledge, to build up the design knowledge, thereby supporting the design works.

The persona process template producing means 106 produces a personal process template to be used for design work assistance from the process template database 102. The knowledge relating means 107 describes a destination address for storing into both the personal process template and the common process template, which are produced in the design work tool 103 and are stored into the knowledge database 104, thereby establishing a relation between the process template and the design knowledge. The useful knowledge extracting means 108 compares the design knowledge related to the personal process template and the design knowledge related to the common process template, and thereby extracts only useful knowledge. The knowledge visualizing means 109 displays the useful knowledge, which is extracted by the useful knowledge extracting means 108 on an operation screen.

In the present system, the knowledge database 104 is described to be a one unified or centralized database. This knowledge database may be a group of databases, which are distributed for each kind of the design knowledge to be stored. Also, there may be possibility of handling the process template itself to be one of the design knowledge databases. Further, it is also possible to treat the process template registered in the process template database 102 as the design knowledge, thereby relating it to other process templates. Namely, it is possible to treat the process template database 102 to be one kind of the knowledge database 104. When treating a precedent case of design work to be the design knowledge, for example, the process templates of the past are related to the process templates, which are under working at present.

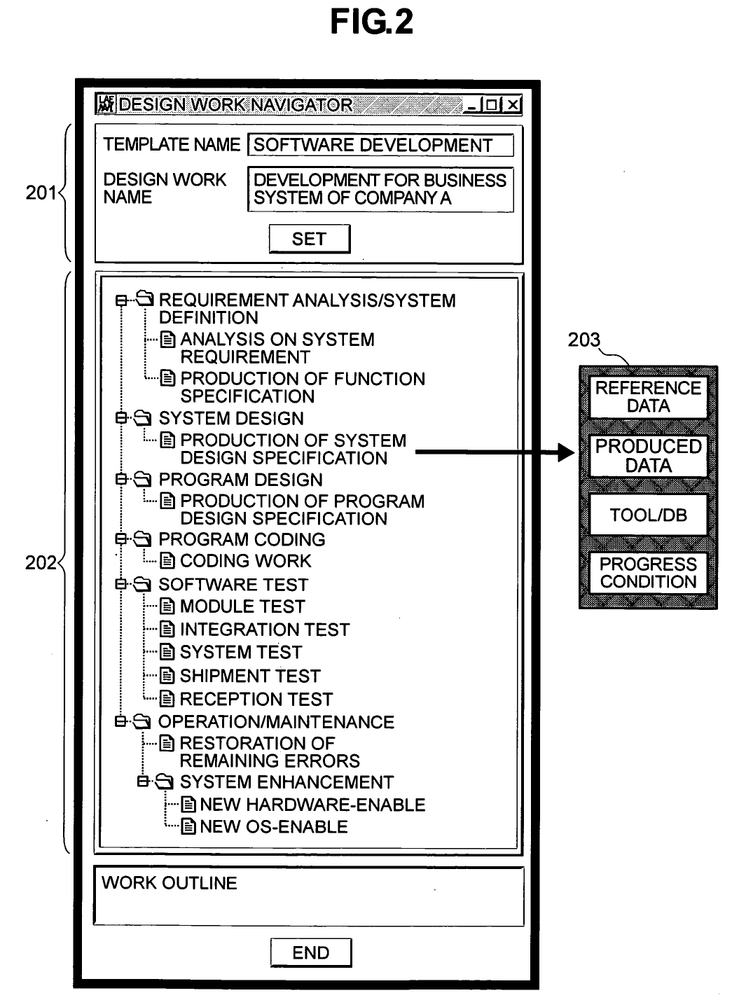

Explanation will be given about an example of the process template, in more details thereof, below. FIG. 2 shows an example of the process template. In this FIG. 2, a design development process of the software system is defined to be the process template. As attribution information 201 common with the process templates are set a title of the template (e.g., a software development, in the case of FIG. 2) and/or a design work title (e.g., a development of business system of a company A, in the case of FIG. 2). As a design work process 202, the work processing is described, in a hierarchical manner, along with the steps of the design works. Namely, in FIG. 2, under the outlined design steps, including an analysis of demand, a definition of system, a system design, a program design, a program coding, a software test, and an operation and maintenance, there are defined the further detailed work steps thereof. Each one of those work processes, which are defined herein, will be called, such as, by a “unit process”, hereinafter.

A user designates the icons of the unit processes, sequentially, from the above, thereby executing the design work set in each of each unit processes. When the user designates the icon of the unit process, a pop up menu 203 is displayed on a screen, which has commands of reference data, production of documents, tool/DB, and the condition of progress. Here, in a case when selecting a command of the reference data, a list of the data to be referred to is displayed thereon; therefore it is possible to select the data therein, to refer to. In a case when selecting a command of the production of document, there is displayed a list of formats of the documents to be produced; therefore it is possible to produce the document by selecting a necessary format among of them. When selecting a command of the tool/DB, there is displayed a list of the design work tools and/or the databases, which will be necessary for the user; therefore it is possible to use those by selecting thereof. When selecting a command of the condition of progress, it is possible to check or confirm the present condition on progress with respect to an initial or original schedule thereof.

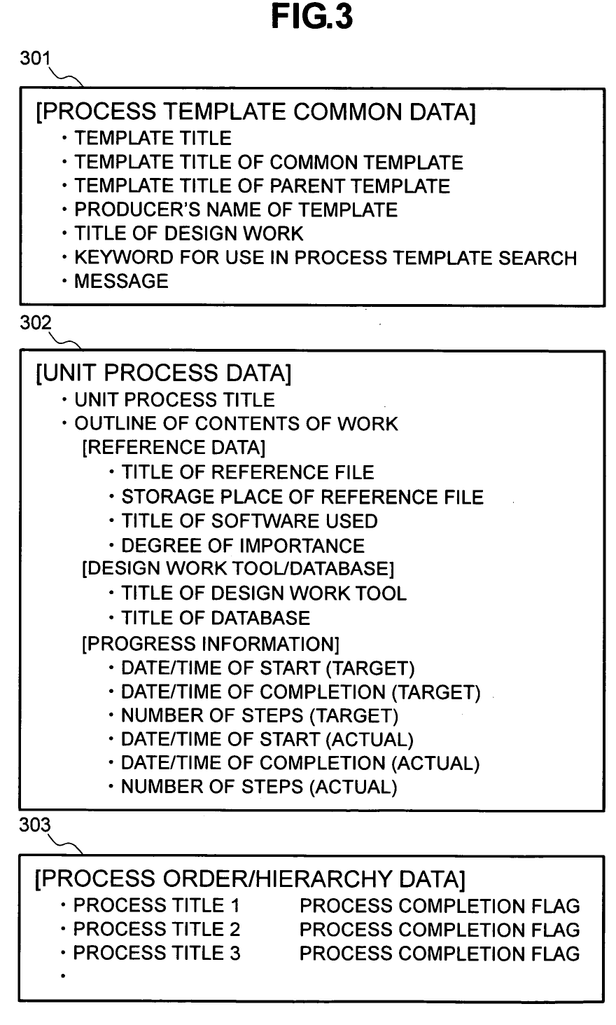

FIG. 3 shows an example of the data structure of the process template. Roughly, the structure of the process template can be divided into three (3) pieces of parts thereof. A first part is data 301 being common with the process templates. The process template common data 301 comprises the following data: such as, a template title of the common template; a template name of a parent template, a producer's name of the template; a title of design work; a mane of the worker; a keyword for use in search of the process template; and message, etc. Herein, the template title, the template title of the common template, the template title of the parent template, and the producer's name of the template are inputted, only at the time when the process template is produced, renewed, or copied. The data, such as, the design work title, the worker's name, and the keyword for use in search of the template are inputted at the time when the design work starts upon selection of the template. The message is inputted at the time when the design work is ended or interrupted. And, when this template is used, the message information is transmitted to that design worker.

A second part is a unit process data 302, and it is defined for each of the unit processes. In, the unit process data are described the data relating to, such as, a title of the unit process, an outline of contents of the work, the reference data, the produced documents, the design work tool/databases, and the condition of progress, for example. With each of the reference data and the produced documents, it is possible to set a parameter of importance thereof, for both of them. In case of the reference data, that having high necessity of reference is distinguished by a degree of importance, and in case of the produced documents, that having a high order in the priority of production is distinguished by the degree of importance.

A third part is process order/hierarchy data 303. Herein, about the unit processes described in the unit process data 302 mentioned above, the data is described relating to the order for them to be executed and a parent-child relationship between those unit processes. Further, a process completion flag is set for each of the unit processes, which is described at the time when the processing is completed on the unit process. With that information, even though the design work is interrupted on the way thereof, it is possible to revive or reproduce the condition at the time when it is interrupted, when the design work is re-started.

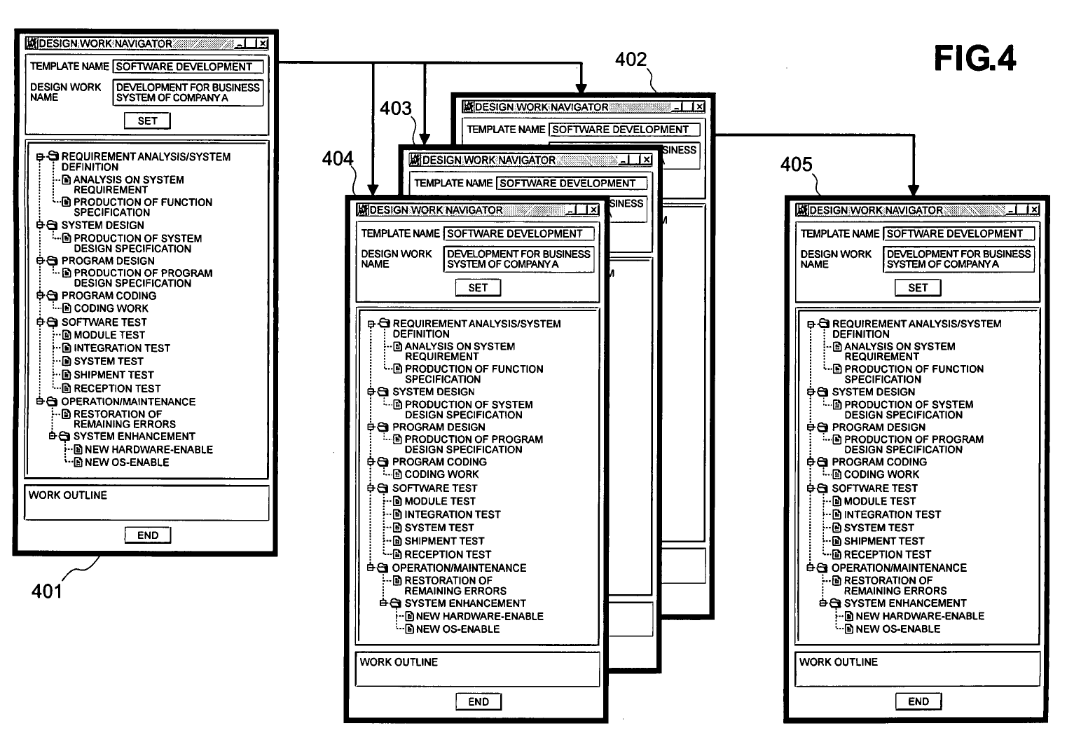

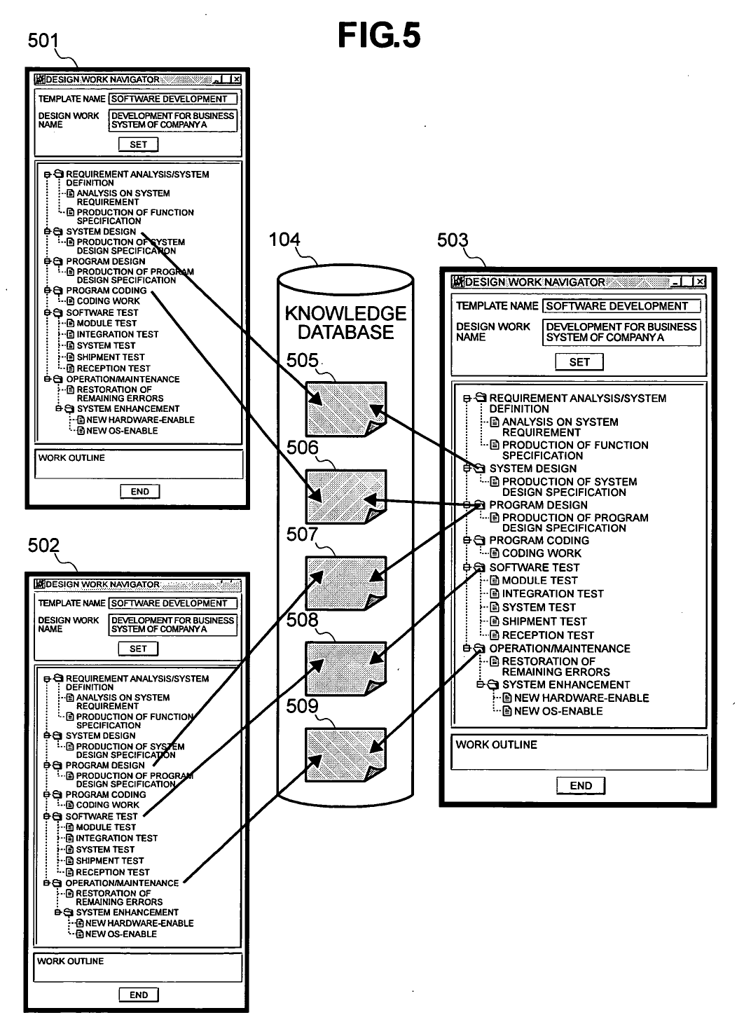

FIG. 4 shows a relationship between the common process template and the personal process template. The common template 401 is a process template, which is produced initially, and it is only one process template, as far as no change is made on the structure or the order of the work process. If any change is made on the structure and/or the order of the common process template, then it is treated as to be another common process template, thereafter. The personal process templates 402-404 are process templates, each of which is produced by copying the common process template. And, one that is produced by further copying the personal process template, which was copied from the common process template 401, is also a personal process template 405. In this FIG. 4, all the process templates 402-405, excepting for the process template 401, are the personal process templates.

The parent-child relationship of the process templates is established between the process templates, which are copied. In the example shown in FIG. 4, the parent-child relationship is built up between the process templates 401 and 401, between the process templates 401 and 403, between the process templates 401 and 404, and between the process templates 402 and 405, respective. In the case where the personal process template is produced by copying thereof, a unique title of the personal process template is set as the template title. Namely, for describing the relationship among the common process templates and/or the parent process templates, the template titles of those are set, necessarily. For example, for the personal process template shown in FIG. 4 is described a template title 401 as to be the title of the common process template, while a template title 402 as to be the title of the parent process template.

FIG. 5 shows the relationship among the common process template and the personal process template and the knowledge database. In a case where the design works are done with using the personal process template, the design knowledge produced is stored into the knowledge database 104 while relating it to the work process corresponding thereto. In that instance, it is also related to the same work process of the common process template. In an example shown in FIG. 5, the design knowledge, which are registered in the knowledge database 104 as the design knowledge by means of the personal process templates 501 and 502, are the design knowledge 505 and 506, and also the design knowledge 507-509. All of those design knowledge are related to each of the work processes of the common process templates 503, automatically. In particular, the design knowledge 506 and 507 are related to the same work processes described in the common process templates 503. Namely, the common process templates establish the relationships on all of the design knowledge, which are produced on the personal process templates copied.

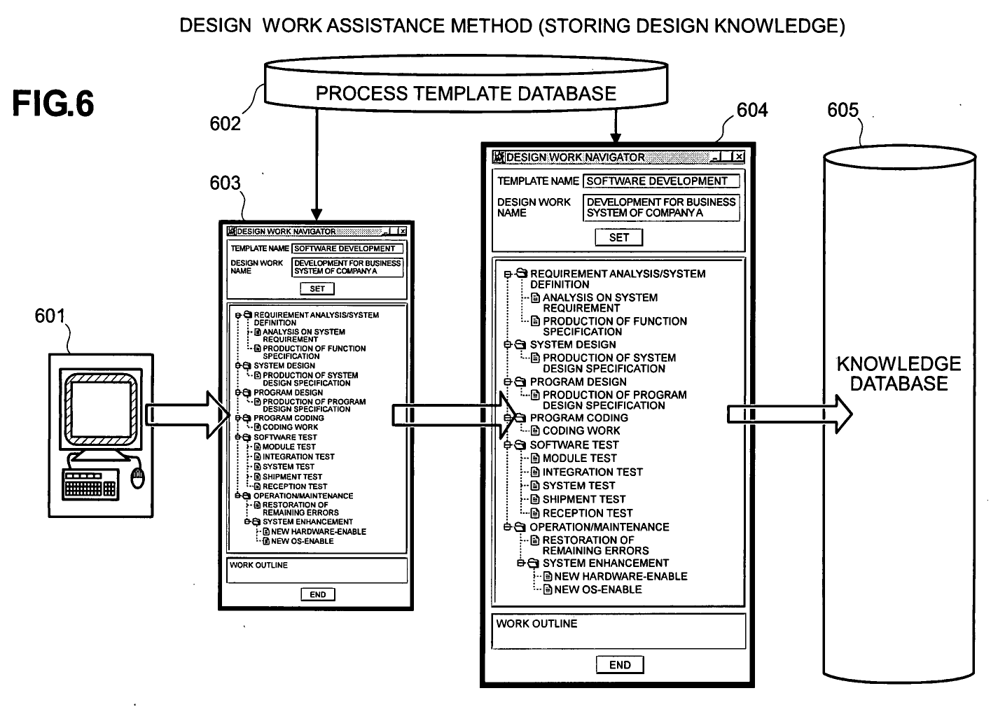

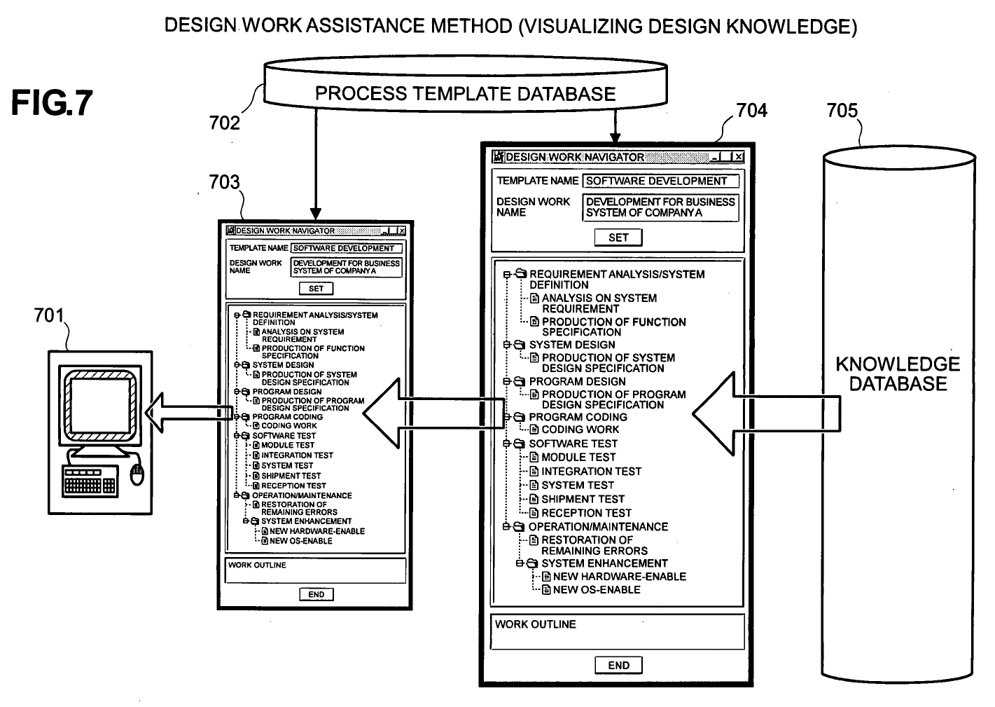

Hereinafter, explanation will be given on a method for assisting the design works, while extracting appropriate design knowledge in various designing scenes, among the design knowledge stored in the design work processes, so as to provide it to each of the design workers. FIG. 6 shows a concept of a process for storing the design knowledge. When storing the design knowledge, the storage destination address of the design knowledge, which is registered in the knowledge database 104, is related to the personal process template 603 and the same work processes of the common process template 604. FIG. 7 shows a concept of a process of visualizing the design knowledge. In the visualization of the design knowledge, all of the design knowledge, which are related to the work processes of the common process template 704, are searched out from the knowledge database 104, and the design knowledge searched out is compared with the design knowledge, which is related to the work process, being same to the personal process template 703, so as to select the useful design knowledge, thereby providing it to the design worker.

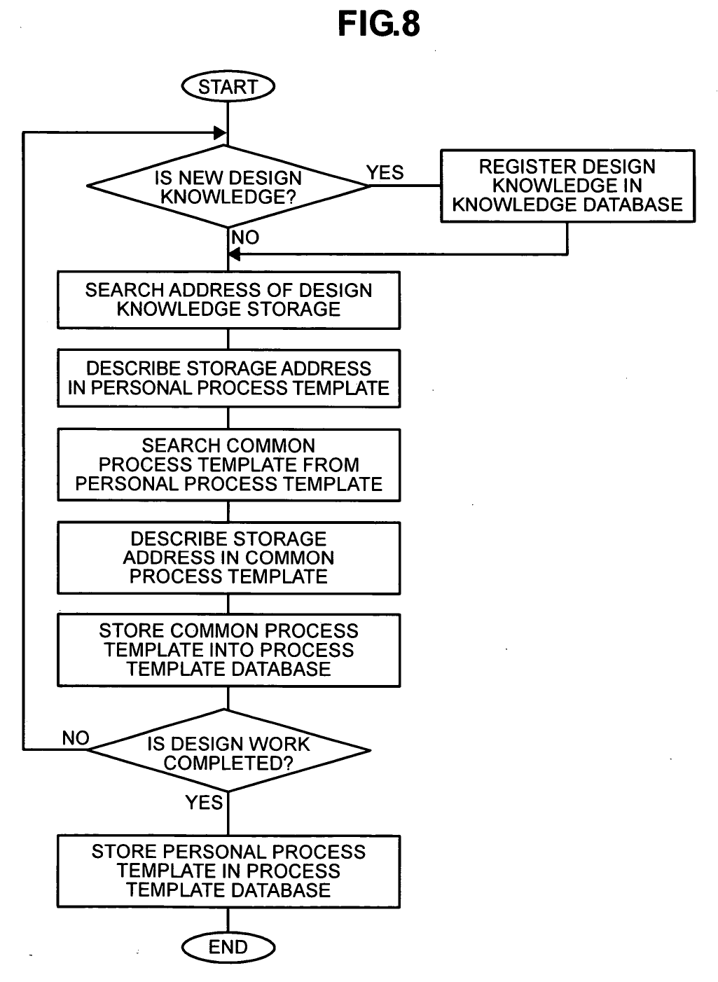

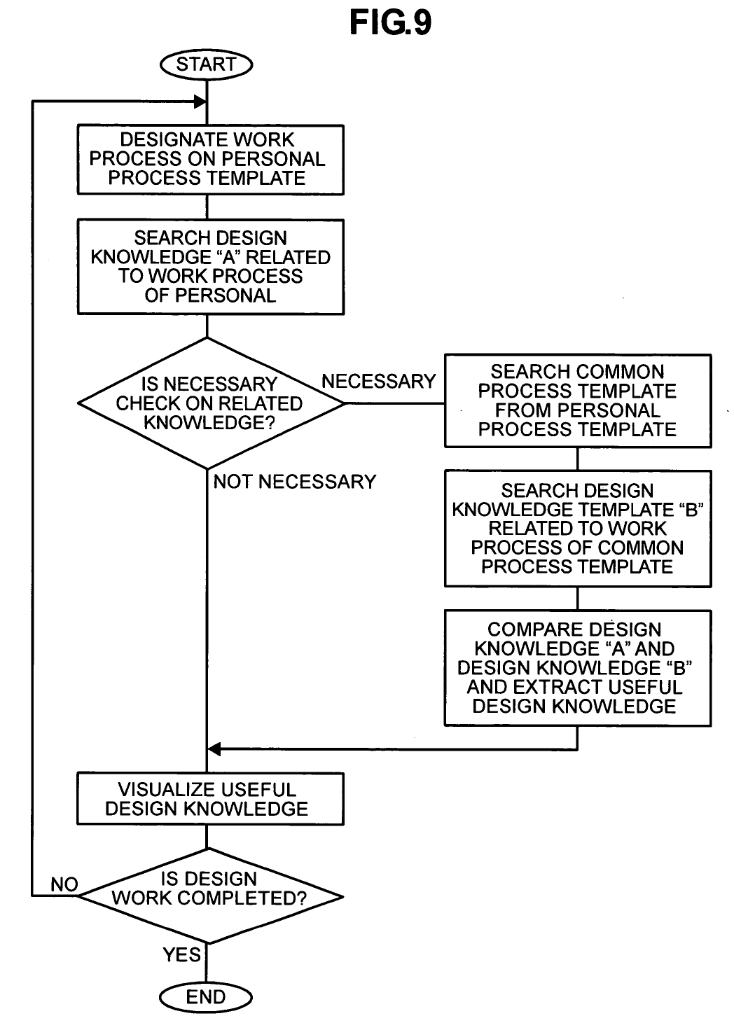

FIG. 8 shows the processing steps for storing the design knowledge, in the form of a flowchart thereof. Decision is made on whether the design knowledge picked up is new one or not. In case when being decided to be the new design knowledge, it is registered into the knowledge database 104. When completing the registration thereof, or when decided not to be the new design knowledge, an address is searched out for the storage destination of the design knowledge. Then, the storage destination address is described in the personal process template. And, the common process template is stored into the process template database 102. Next, decision is made on whether the design work is completed or not. In case when being decided not to be completed, the process turns back to the decision step on whether it is the new design knowledge or not, thereby repeating the processes up to now. In the case where the design work is completed, the personal process template is stored into the process template database 102.

FIG. 9 shows the processing steps of the design knowledge visualization, in the form of the flowchart thereof. Designation is made on the work process of the personal process template. Then, the design knowledge A is searched out, which is related to the work process of the personal process template. Next, it is decided on whether comparison should be made or not on the knowledge related thereto. In the case where the comparison is necessary on the related knowledge, the common process template is searched out from the personal process templates. Search is conducted on the design knowledge B, which is related to the work process of the common process template. Then, comparison is made between the design knowledge A and the design knowledge B, thereby extracting the useful design knowledge therefrom. In the case where no comparison is necessary on the related knowledge, or when completing the comparison on the related knowledge, visualization is made on the useful design knowledge. Thereafter, it is decided on whether the design work is completed or not. If it is not completed yet, the process turns back to the step for designating the work process of the personal process template, and thereby repeating the steps up to now. When the design work is completed, it ends as it is.

Hereinafter, explanation will be given on the details of the visualization of the design knowledge.

(1) Visualization of the Useful Knowledge when Re-Starting the Design Work:

For example, when re-starting the design work, which was temporarily interrupted one (1) month before, the design worker searches out various data and/or materials related thereto, for the purpose of recognizing the progress condition on the designing at the time when it was interrupted. In that instance, for the design worker, the most important design knowledge is the design data or the like, which she/he handled at that time of that interruption. Then, according to the present embodiment, searching is made on the design knowledge at that time when the design work was interrupted, automatically, thereby providing it to the design worker.

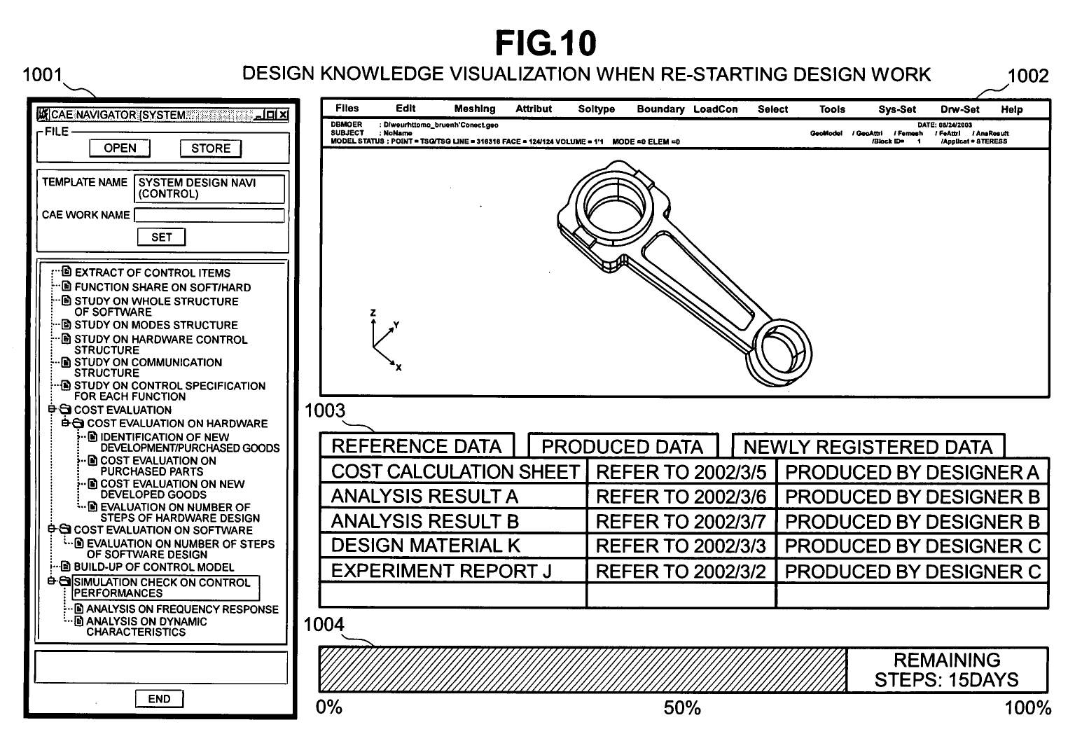

The work process is identified, on which the design work is interrupted, from the personal process template. Search is conducted on the design knowledge, which is related to this work process, and then the design knowledge referred to at the last is displayed on the operation screen, being selected among of those. With the design knowledge other than this, a list thereof is displayed on the screen, as the related knowledge. In that instance, classification is done on the design knowledge referred to and the design knowledge produced and so on, thereby to be displayed on the list thereof. When wishing to refer to the contents of the related knowledge, she/he designates the related knowledge on the list. Then, the related knowledge is displayed on the operation screen. With the related knowledge registered into the knowledge database during the interruption of design works, it is extracted through search of the design knowledge, which is related to the common process template, and through selection of the design knowledge from them, which are registered during the interruption of design works. This related knowledge is also displayed on the list. Further, with the progress condition thereof, a degree of progress and a number of steps at the time when interrupting the design work are calculated out from the step information described in the work process, and it is displayed on the screen. FIG. 10 shows an example of the operation screen, which is displayed when the design work is re-started. The operation screen, when re-starting the design works, displays thereon a personal process template 1001, design knowledge 1002 at the time when the design work was interrupted, a list of related knowledge, and a graph of progress condition 1004.

(2) Visualization of New Information and/or Design Knowledge of High Publicity thereof:

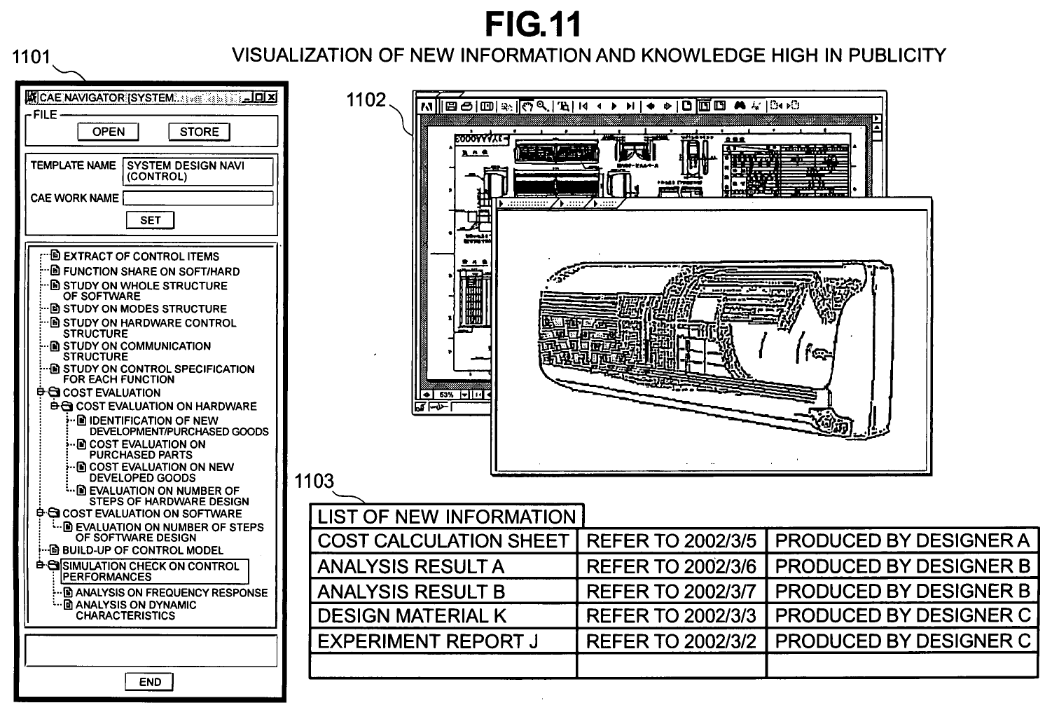

With new information and/or the design knowledge being high in frequency of being referred to among other designers, it/they is/are useful knowledge for the design workers, who do not refer to those yet. According to the present embodiment, those design knowledge are extracted and visualized with the processing steps, which will be shown below. On the personal process template, the work process “P” is identified, which is now under the working. Search is conducted on a group “A” of design knowledge, which are related to the work process “P” and all of the work processes before the work process “P”. Next, Search is conducted on a group “B” of design knowledge, which are related to the work process “P” of the common process template. Finally, a group “C” of design knowledge, which are included in the group “B” of design knowledge but not being included in the group “A” of design knowledge, is displayed in the form of a list of new information. When relating the design knowledge to the common template, with the design knowledge that was already related to in advance, it is described in the common template by the number of times of building up the relation, thereby it is possible to remain it, as the information of frequency of references. With that being high in the reference frequency within the group “C” of design knowledge, it is possible to visualize the contents of the design knowledge, more aggressively. FIG. 11 shows an example of displaying the new information and the design knowledge of being high in publicity on the operation screen. This operation screen displays thereon a personal process template 1101, design knowledge 1102 of being high in publicity, and a list 1103 of new information.

In the present embodiment, there is newly provided the personal process templates, while dividing or breaking up the relation between the common process templates and the design knowledge, thereby extracting the useful design knowledge for each of the design workers, and therefore it is possible to visualize the optimal design knowledge, on an appropriate design scene. Further, comparing the design knowledge related to the personal process template and the design knowledge related to the common process template, it is possible to extract only the useful knowledge, to be visualized. As a result thereof, it is possible to cut down wasteful works, such as, finding out the useful design knowledge from an expansive number of design knowledge or the like. Also, it is possible to achieve a productive design works with using the knowledge effectively, while reducing a burden upon the design workers of searching out the design knowledge.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A design work assistance apparatus, for guiding design works, sequentially, along with a process template, defining steps of design works therein, comprising:
a personal process template producing means for producing a template for use of personal works from a common process template, indicating flows of design work processes by an order of unit work processes;
a relation means for relating design knowledge, including design information and design tools therein, to said common process template and said personal process template, thereby storing them into a knowledge database;
a useful knowledge extraction means for extracting the design knowledge to be provided for design workers from said common process template and said personal process template; and
a knowledge visualizing means for visualizing the design knowledge extracted, thereby to be provided for each of the design workers.

2. A design work assistance apparatus, as described in the claim 1, further comprising means for relating said design knowledge to the same work process for the common process template, when relating the design knowledge to the work process of the personal process template.

3. A design work assistance apparatus, as described in the claim 1, further comprising means for searching the design knowledge, which was referred to at time when interrupting the design works, when re-starting the design works temporarily interrupted, thereby displaying it on an operation screen.

4. A design work assistance apparatus, as described in the claim 1, further comprising means for extracting the design knowledge, to which no reference is made in past.

5. A design work assistance apparatus, as described in the claim 1, further comprising means for extracting design knowledge being high in frequency of references.

6. A design work assistance apparatus, as described in the claim 2, further comprising means for searching the design knowledge, which was produced and/or referred to at the time when the design work is interrupted, when re-starting the design works that is interrupted temporarily.

7. A design work assistance apparatus, as described in the claim 2, further comprising means for extracting the design knowledge, to which no reference was made in past.

8. A design work assistance apparatus, as described in the claim 2, further comprising means for extracting design knowledge being high in frequency of references.

9. A design work assistance apparatus, as described in the claim 3, further comprising means for extracting the design knowledge, to which no reference was made in past.

10. A design work assistance apparatus, as described in the claim 3, further comprising means for extracting design knowledge being high in frequency of references.

11. A design work assistance apparatus, as described in the claim 4, further comprising means for extracting design knowledge being high in frequency of references.

12. A design work assistance apparatus, for guiding design works, sequentially, along with a process template, defining steps of design works therein, comprising:
a personal process template producing means for producing a template for use of personal works from a common process template, indicating flows of design work processes by an order of unit work processes;
a relation means for relating design knowledge, including design information and design tools therein, to said common process template and said personal process template, thereby storing them into a knowledge database;
a useful knowledge extraction means for extracting the design knowledge to be provided for design workers from said common process template and said personal process template;
means for relating said design knowledge to the same work process for the common process template, when relating the design knowledge to the work process of the personal process template;
means for searching the design knowledge, which was referred to at time when interrupting the design works, when re-starting the design works temporarily interrupted, thereby displaying it on an operation screen;
means for extracting the design knowledge, to which no reference is made in past;
means for extracting design knowledge being high in frequency of references; and
a knowledge visualizing means for visualizing the design knowledge extracted, thereby to be provided for each of the design workers.
